(19) United States
(12) Patent Application Publication
(10) Pub. No.: US 2015/0009923 A1
(43) Pub. Date: Jan. 8, 2015

(54) Method and Apparatus to Report and Handle Buffer Status for User Equipment Working in Inter-Site Carrier Aggregation Mode

(71) Applicant: Nokia Corporation, Espoo (FI)

(72) Inventors: Haipeng Lei, Beijing (CN); Kodo Shu, Beijing (CN)

(21) Appl. No.: 14/372,336

(22) PCT Filed: Feb. 7, 2012
(86) PCT No.: PCT/CN2012/070935

§ 371 Date: Jul. 15, 2014

(51) Int. Cl. H04L 5/00; H04W 72/04

(52) U.S. Cl. CPC H04L 5/0035; H04W 72/0413
USPC 370/329

(57) ABSTRACT

In inter-site carrier aggregation (CA) mode, a user equipment (UE) may benefit from methods and systems for handling UE buffer status reports. For dual-carrier uplink control information transmission mode, for example, the user equipment can send the buffer status report only to the Pico eNode B (eNB). Then, the Pico can send the updated buffer status report to the Macro via an X2 interface so as to shift some traffic load to a primary cell (PCell) and guarantee a load balance between two eNBs. Before sending, the Pico can exclude a possibly scheduled amount on secondary cell (SCell) according to the uplink traffic load.

### BACKGROUND

1. Field

In inter-site carrier aggregation (CA) mode, a user equipment (UE) may benefit from methods and systems for handling UE buffer status reports. These methods and systems may be applicable to communication systems including, for example, the long term evolution (LTE) of the third generation partnership project (3GPP).

2. Description of the Related Art

LTE TS36.213 Rel-8/9/10, which are hereby incorporated by reference in their entirety, conventionally only supports co-site carrier aggregation (CA). Co-site refers to the situation in which a primary cell (PCell) and secondary cell (SCell) are configured for the same eNB. Conventionally, the buffer status report (BSR) of the UE is sent to a co-sited eNB that contains both PCell and SCell.

Thus, conventional approaches to inter-site carrier aggregation can be that buffer state reports (BSRs) are always transmitted on both PCell and SCell, that the user equipment decides if it transmits buffer status report on PCell or SCell, or the buffer status report is always transmitted on PCell only.

However, if buffer status reports are always transmitted on both PCell and SCell, this conventionally requires sufficient physical uplink shared channel (PUSCH) capacity to be scheduled on PCell and SCell. In inter-site carrier aggregation, because the user equipment is near the Pico, PUSCH is conventionally assumed to be mainly transmitted on SCell. So it is difficult to guarantee sufficient PUSCH capacity on PCell. Moreover, since this buffer status report is not carrier-specific, the Pico eNB does not conventionally know whether the Macro eNB has sufficient uplink radio resource for scheduling and how many uplink resources are available at PCell. Moreover, this approach is only for a user equipment (UE) with dual radio frequency (RF) units in transmission (Tx), which is not supported by all UEs.

If the user equipment can decide buffer status report transmission on PCell or SCell, buffer status report information conventionally needs to be exchanged periodically between two eNBs. Moreover, user equipment conventionally needs to know some uplink scheduling information of PCell and SCell in order to the decision of buffer status report transmission on PCell or SCell, which is difficult and not possible from the point of user equipment implementation.

If the user equipment only transmits buffer status report on PCell, then the buffer status report conventionally needs to be forwarded to the Pico periodically. The Macro, in the conventional system, needs to allocate sufficient PUSCH on PCell to guarantee the transmission and thus uplink scheduling can be impacted.

### SUMMARY

According to certain embodiments, a method includes sending, by a user equipment in a dual carrier mode carrier aggregation configuration, uplink traffic information only to a first base station selected from a pair of base stations. The method also includes receiving a first uplink resource assignment from the first base station.

In certain embodiments, a method includes receiving uplink traffic information from a user equipment in a dual carrier mode carrier aggregation configuration. The method also includes assigning, at a first base station, uplink resources to the user equipment. The method further includes sending, from the first base station, an updated uplink traffic information to a second base station.

A method, according to certain embodiments, includes receiving an updated uplink traffic information from a first base station of a pair of base stations. The method also includes assigning uplink resources to a user equipment to which the updated uplink traffic information relates.

According to certain embodiments, an apparatus includes at least one processor and at least one memory including computer program code. The at least one memory and computer program code are configured to, with the at least one processor, cause the apparatus at least to send, by a user equipment in a dual carrier mode carrier aggregation configuration, uplink traffic information only to a first base station selected from a pair of base stations. The at least one memory and computer program code are also configured to, with the at least one processor, cause the apparatus at least to receive a first uplink resource assignment from the first base station.

In certain embodiments, an apparatus includes at least one processor and at least one memory including computer program code. The at least one memory and computer program code are configured to, with the at least one processor, cause the apparatus at least to receive uplink traffic information from a user equipment in a dual carrier mode carrier aggregation configuration. The at least one memory and computer program code are also configured to, with the at least one processor, cause the apparatus at least to assign, at a first base station, uplink resources to the user equipment. The at least one memory and computer program code are further configured to, with the at least one processor, cause the apparatus at least to send, from the first base station, an updated uplink traffic information to a second base station.

An apparatus includes, in certain embodiments, at least one processor and at least one memory including computer program code. The at least one memory and computer program code are configured to, with the at least one processor, cause the apparatus at least to receive an updated uplink traffic information from a first base station of a pair of base stations. The at least one memory and computer program code are configured to, with the at least one processor, cause the apparatus at least to assign uplink resources to a user equipment to which the updated uplink traffic information relates.

According to certain embodiments, an apparatus includes sending means for sending, by a user equipment in a dual carrier mode carrier aggregation configuration, uplink traffic information only to a first base station selected from a pair of base stations. The apparatus also includes receiving means for receiving a first uplink resource assignment from the first base station.

In certain embodiments, an apparatus includes receiving means for receiving uplink traffic information from a user equipment in a dual carrier mode carrier aggregation configuration. The apparatus also includes assigning means for assigning, at a first base station, uplink resources to the user equipment. The apparatus further includes sending means for sending, from the first base station, an updated uplink traffic information to a second base station.

An apparatus, according to certain embodiments, includes receiving means for receiving an updated uplink traffic information from a first base station of a pair of base stations. The apparatus also includes assigning means for assigning uplink resources to a user equipment to which the updated uplink traffic information relates.

According to certain embodiments, a non-transitory computer readable medium is encoded with instructions that, when executed in hardware, perform a process. The process includes sending, by a user equipment in a dual carrier mode carrier aggregation configuration, uplink traffic information only to a first base station selected from a pair of base stations. The process also includes receiving a first uplink resource assignment from the first base station.

In certain embodiments, a non-transitory computer readable medium is encoded with instructions that, when executed in hardware, perform a process. The process includes receiving uplink traffic information from a user equipment in a dual carrier mode carrier aggregation configuration. The process also includes assigning, at a first base station, uplink resources to the user equipment. The process further includes sending, from the first base station, an updated uplink traffic information to a second base station.

A non-transitory computer readable medium, according to certain embodiments, is encoded with instructions that, when executed in hardware, perform a process. The process includes receiving an updated uplink traffic information from a first base station of a pair of base stations. The process also includes assigning uplink resources to a user equipment to which the uplink traffic information relates.

### BRIEF DESCRIPTION OF THE DRAWINGS

For proper understanding of the invention, reference should be made to the accompanying drawings, wherein:

FIG. 1 illustrates a typical inter-site carrier aggregation in a Macro-Pico case.

FIG. 2(a) illustrates dual-carrier uplink control information transmission and FIG. 2(b) illustrates single-carrier uplink control information transmission.

FIG. 3 illustrates buffer status report transmission for single-carrier uplink transmission.

FIG. 4 illustrates buffer status report transmission for dual-carrier uplink transmission.

FIG. 5 illustrates a method according to certain embodiments.

FIG. 6 illustrates a system according to certain embodiments.

### DETAILED DESCRIPTION

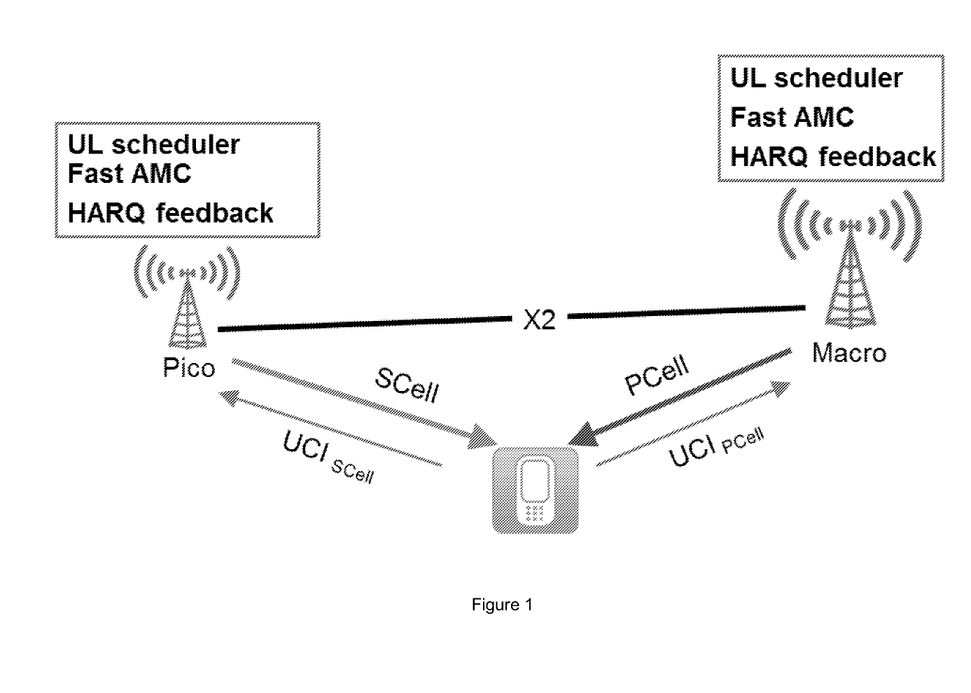

Carrier aggregation (CA), in which two or more component carriers are aggregated can be used to support wide transmission bandwidths, such as up to 100 MHz. For inter-site carrier aggregation, multiple carriers can be transmitted from multiple sites in downlink and multiple carriers can be transmitted to multiple sites in uplink. Inter-site carrier aggregation can provide dynamic multilayer traffic steering or offloading, enhance data rate in overlapped coverage region of two/multiple cells or transmission points and reduce handover overhead in heterogeneous networks (HetNet). Macro-Pico is an example scenario with two-carrier configuration. A primary cell (PCell) can be configured to serve as the Macro eNode B (eNB) and the secondary cell (SCell) can be configured to serve as the Pico eNB, which is illustrated in FIG. 1.

In case of inter-site carrier aggregation, if the corresponding uplink control information (UCI) of PCell and SCell are only transmitted to one site, then the uplink control information aimed for another site can be forwarded via an X2 interface between the Pico and the Macro. In view of about 20 ms of X2 interface delay, fast AMC and HARQ feedback may not be adopted or guaranteed. Alternatively, the user equipment can separately transmit the UCIs of PCell and SCell to the Macro and the Pico in uplink for independent A/N feedback or CSI reporting at different sites.

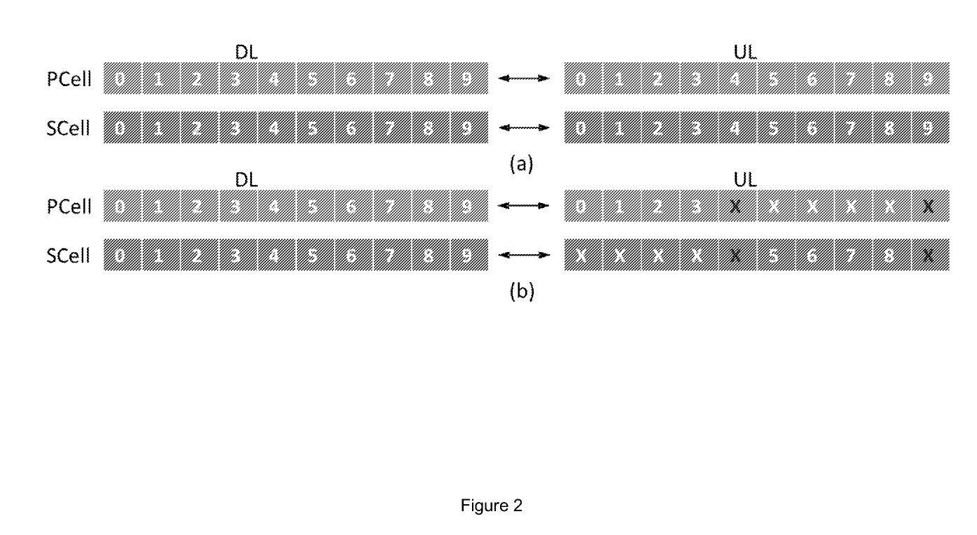

There are at least two uplink control information transmission schemes for inter-site carrier aggregation: a dual-carrier uplink control information transmission and a single-carrier uplink control information transmission. For dual-carrier uplink control information transmission, which is illustrated in FIG. 2(a), the user equipment simultaneously transmits independent uplink control information on the corresponding carrier in uplink. Two radio frequency (RF) units may be required in uplink transmission. Moreover, dual-carrier transmission may have limited uplink coverage because of power limitation in terminal. For the single-carrier uplink control information transmission scheme that is shown in FIG. 2(b), user equipment switches between the two uplink carriers by time division multiplexing (TDM) to send the uplink control information of each cell. Single-carrier uplink control information transmission can simplify the user equipment implementation due to requiring only one RF unit in uplink Tx. Moreover, it can provide better uplink coverage. In FIG. 2(b), a light “X” means no uplink transmission in this subframe due to TDM switching and a dark “X” means the blanked subframe is due to the gap for the user equipment to tune the local oscillator to a new frequency from the point of user equipment implementation. For single-carrier uplink control information transmission, different ratios of uplink subframes between the PCell and the SCell can be set, which are called uplink Tx switching patterns.

A buffer status report (BSR) is a control element in the medium access control (MAC) layer, which is used to provide the serving eNB with the information about the amount of data available for transmission in the uplink buffers of a user equipment. A buffer status report is typically transmitted only on PUSCH and terminated at the MAC layer, that is, it is terminated in the node where PUSCH is received. If PUSCH is available on both PCell and SCell, it can be sent on either. Only one buffer status report is typically transmitted, corresponding to all active carriers. Alternative buffer status reports and other indications of buffer status, such as an indication of a buffer of a serving eNB to a user equipment, can also be used, and therefore the following examples in which the buffer status relates to the buffer of the user equipment should be considered illustrative examples.

The buffer status report can be triggered according to certain configurations to report the information on the remaining amount of data in the certain user equipment logical buffer after successful transmission of the current PUSCH. That is, buffer status information is not necessarily carrier-specific. When the PCell and SCell are co-sited, the actual cell used for the transmission of the buffer status report is less significant. However, in the case of inter-site carrier aggregation, because the Macro eNB and the Pico eNB are terminated in different nodes, each eNB performs radio resource management independently according to independent uplink control information feedback on PCell and SCell. Since the PCell and the SCell are not co-sited, buffer status information needs to be reported to both PCell and SCell for independent radio resource management. Therefore, certain embodiments specify how to transmit and handle buffer status report for user equipment working in inter-site carrier aggregation mode.

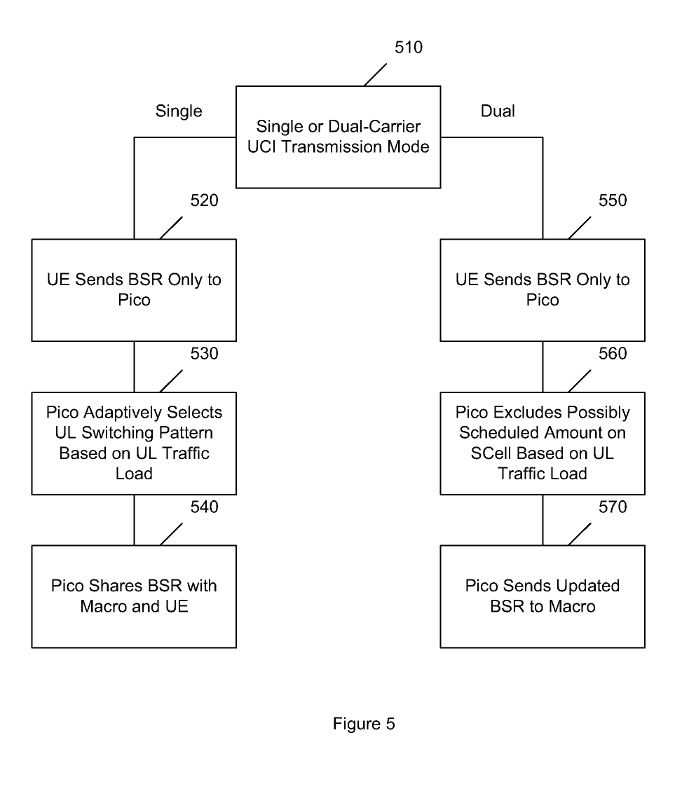

Certain embodiments provide for buffer status report transmission from the user equipment working in inter-site carrier aggregation mode and specify the buffer status report-handling mechanism for the eNB, as can seen—for example—in FIG. 5.

FIG. 5 illustrates a method according to certain embodiments. As shown in FIG. 5, a user equipment, or the configurer of the user equipment, such as a manufacturer, can determine whether single-carrier uplink control information transmission mode or dual-carrier uplink control information transmission mode is applicable, at 510. For single-carrier uplink control information transmission mode, the user equipment can always send buffer status report only to the Pico, at 520. Then, at 530 the Pico can adaptively select an appropriate uplink switching pattern according to the uplink traffic amount. Finally, at 540, the Pico can share the switching pattern with the Macro and user equipment.

For dual-carrier uplink control information transmission mode, at 550 the user equipment can send the buffer status report only to the Pico. Then, at 570 the Pico can send the updated buffer status report to the Macro via X2 so as to shift some traffic load to PCell and guarantee the load balance between two eNBs. Here, this updated buffer status report is used to provide with the partial data amount information obtained by excluding the possibly scheduled amount on SCell from the data amount in BSR reported by the UE. Before sending, at 560, the Pico can exclude a possibly scheduled amount on SCell itself according to the uplink traffic load.

As a result of the above method, the data in user equipment buffer may be transmitted timely and efficiently.

In case of inter-site carrier aggregation, since the user equipment is relatively nearer the Pico, the difference in effective radiated power between the Macro and the Pico may be up to, for example, 30 dB. For uplink data transmission, it may be useful to carry data to the Pico eNB. For example, PUSCH can be mainly transmitted on SCell. On the other hand, there are two uplink transmission modes that can be considered separately.

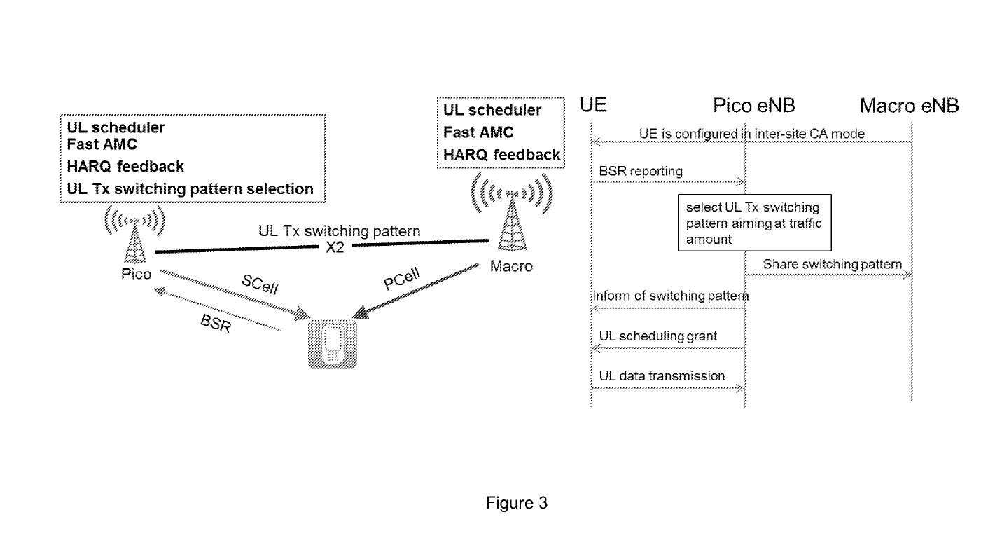

For single-carrier uplink control information transmission mode, the user equipment can switch between PCell and SCell by TDM during an uplink transmission procedure. There are several uplink Tx switching patterns with different uplink subframe ratios between PCell and SCell designed to address the traffic variation. In this case, the Pico eNB can have the authority to decide which uplink Tx switching pattern is used. The Pico cell can adaptively allocate the uplink radio resource to SCell by selecting an appropriate uplink Tx switching pattern considering the uplink traffic amount. Thus, in certain embodiments the user equipment can always send buffer status reports only to the Pico and the Pico can adaptively select the uplink switching pattern according to the amount of data in the user equipment buffer, and then send the decided pattern to the Macro. A concrete illustration and procedure, providing an example, are shown in FIG. 3.

FIG. 3 illustrates buffer status report transmission for single-carrier uplink transmission according to certain embodiments. Implementation of the single-carrier uplink mode can involve the steps below, as an example. First, the Macro eNB can use radio resource control (RRC) signaling to inform user equipment when it is configured in inter-site carrier aggregation mode. Then, the user equipment can send uplink traffic information, for example, a buffer status report, only to the Pico eNB. Next, the Pico eNB can adaptively allocate uplink radio resources to the SCell by selecting an appropriate uplink transmission (Tx) switching pattern aiming at the uplink traffic amount.

After that, the Pico eNB can share the selected uplink Tx switching pattern with the Macro eNB via an X2 interface and can also inform the user equipment regarding the uplink Tx switching pattern. The Pico can then schedule the uplink resource for user equipment to transmit the data in the buffer.

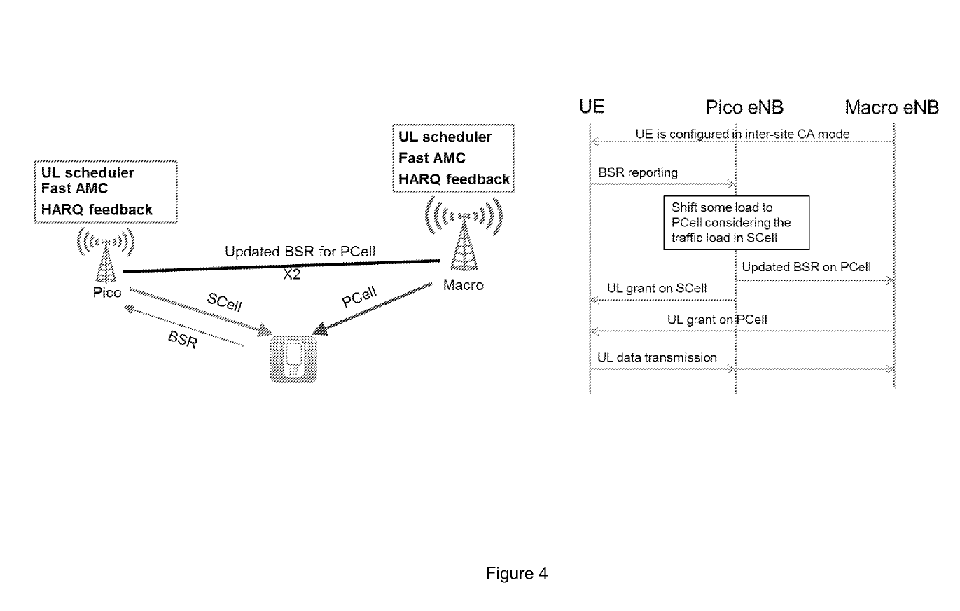

For dual-carrier uplink control information transmission mode, the user equipment can have the ability to simultaneously transmit uplink data or control information on PCell and SCell. Due to better channel conditions to the Pico, the user equipment can always send buffer status reports only to the Pico, for indicating the amount of data in its buffer. Considering the uplink traffic amount in the SCell, the Pico can shift some traffic load to the PCell in order to guarantee a load balance between the two eNBs. Thus, the Pico can send the updated buffer status report, excluding a possibly scheduled amount in SCell according to the uplink traffic load, to the Macro via X2 interface. A concrete illustration and procedure are shown in FIG. 4.

FIG. 4 illustrates buffer status report transmission for dual-carrier uplink transmission, according to certain embodiments. As shown in FIG. 4, the implementation of dual-carrier uplink mode can include the steps set forth below as an example. First, the Macro eNB can use RRC signaling to inform the user equipment when it is configured in inter-site carrier aggregation mode. Then, the user equipment can send uplink traffic information, for example a buffer status report, only to the Pico eNB. Next, the Pico eNB can shift some traffic load to the PCell, considering the traffic load in SCell in order to guarantee a load balance between two eNBs.

Furthermore, the Pico eNB can send the updated buffer status report, excluding the possibly scheduled amount in SCell according to the uplink traffic load, to the Macro eNB via an X2 interface, Finally, the Pico/the Macro eNB can schedule the uplink resource for user equipment to transmit data on SCell/PCell, respectively.

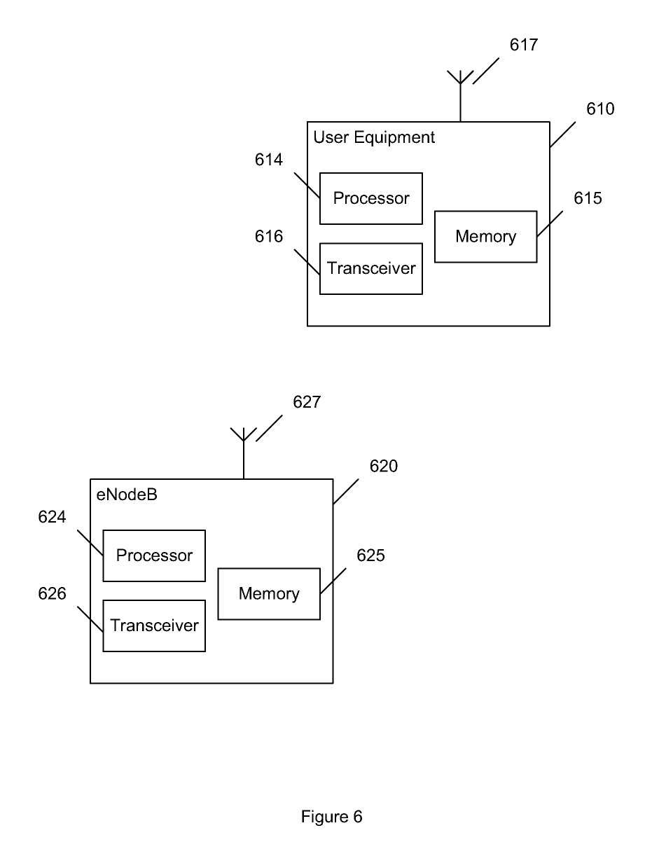

FIG. 6 illustrates a system according to certain embodiments. In an example embodiment, a system may include two kinds of devices, user equipment (UE) 610 and eNodeB 620. As discussed above, two eNodeBs 620 can be present in respective cells, one o of which can be a Pico eNB and the other of which can be a Macro eNB. The construction of the Pico and Micro eNBs can be similar, but there is no requirement that the construction be similar. Each of the devices 610 and 620 may be equipped with at least one processor (respectively 614 and 624), at least one memory (respectively 615 and 625) (including computer program instructions or code), a transceiver (respectively 616 and 626), and an antenna (respectively 617 and 627). There is no requirement that each of these devices be so equipped. For example, the eNodeB 620 may be equipped for wired communication with a core network (not shown). Additionally, two eNodeBs 620 can be connected to one another over an X2 interferences.

The transceiver (respectively 616 and 626) can be a transmitter, a receiver, both a transmitter and a receiver, or a unit that is configured both for transmission and reception. The transceiver (respectively 616 and 626) can be coupled to corresponding one or more antenna(s) (respectively 617 and 627), which may include a directional antenna.

The at least one processor (respectively 614 and 624) can be variously embodied by any computational or data processing device, such as a central processing unit (CPU) or application specific integrated circuit (ASIC). The at least one processor (respectively 614 and 624) can be implemented as one or a plurality of controllers.

The at least one memory (respectively 615 and 625) can be any suitable storage device, such as a non-transitory computer-readable medium. For example, a hard disk drive (HDD) or random access memory (RAM) can be used in the at least one memory (respectively 615 and 625). The at least one memory (respectively 615 and 625) can be on a same chip as the corresponding at least one processor (respectively 614 and 624), or may be separate from the corresponding at least one processor (respectively 614 and 624).

The computer program instructions may be any suitable form of computer program code. For example, the computer program instructions may be a compiled or interpreted computer program.

The at least one memory (respectively 615 and 625) and computer program instructions can be configured to, with the at least one processor (respectively 614 and 624), cause a hardware apparatus (for example, user equipment 610 or eNodeB 620) to perform a process, such as any of the processes described herein (see, for example, FIGS. 1-5).

Thus, in certain embodiments, a non-transitory computer-readable medium can be encoded with computer instructions that, when executed in hardware perform a process, such as one of the processes described herein. Alternatively, certain embodiments of the present invention may be performed entirely in hardware.

The devices of the system may also include additional components. For example, each of user equipment 610 and eNodeB 620 can include a user interface that is operable connected to the processor (respectively 614 and 624) and memory (respectively 615 and 625). That user interface can include a display, such as a liquid crystal display (LCD) or organic electroluminescent display (OELD), as well as speakers or audio outputs. Tactile outputs, such as a haptic feedback system, can also be included. The user interface may have a touch screen to receive user input. User input can also be provided by a keypad, keyboard, microphone, joystick, mouse, trackball, or other input device. Of course, there is no requirement that the devices include a user interface. For example, the eNodeB 620 may be embodied in part as a rack-mounted computer.

In view of the above, in certain embodiments a buffer status report is only reported to a Pico eNB (rather than both Pico and Macro), which can limit overhead. Moreover, scheduling on the PCell corresponding to the Macro can be triggered if the Pico cell cannot entirely allocate the necessary resources.

Moreover, in certain embodiments the relevant uplink scheduling information is guaranteed at the eNB for radio resource management. Moreover, in certain embodiments fast scheduling and HARQ feedback are guaranteed. Furthermore, full use can be made of better channel conditions to the Pico in certain embodiments. Finally, a load balance between two eNBs can be guaranteed by certain embodiments.

Although the discussion above has focused primarily on embodiments in which a partial buffer status report, or other partial traffic information, is sent from a pico eNodeB to a macro eNodeB, the opposite direction transfer is also permitted. Thus, for example, a user equipment can send a buffer status report only to the macro eNodeB and then macro eNodeB can send a partial buffer status report, excluding a portion possibly scheduled on PCell to the pico eNodeB. Other modifications are also possible, such as sending partial buffer status reports to a plurality of pico eNodeBs.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY OF ABBREVIATIONS

CC Component carrier

PCell Primary cell

SCell Secondary cell

BLER Block error ratio

RRM Radio resource management

BSR Buffer status report

SR Scheduling request

CSI Channel state information

UCI Uplink control information

DCI Downlink control information

1-40. (canceled)

41. A method, comprising:
sending, by a user equipment in a dual carrier mode carrier aggregation configuration, uplink traffic information to a first base station selected from a pair of base stations; and
receiving a first uplink resource assignment from the first base station.

42. The method of claim 41, further comprising:
receiving a second uplink resource assignment from a second base station of the pair of base stations.

43. A method, comprising:
receiving uplink traffic information from a user equipment in a dual carrier mode carrier aggregation configuration;
assigning, at a first base station, uplink resources to the user equipment; and
sending, from the first base station, an updated uplink traffic information to a second base station.

44. The method of claim 43, wherein the uplink traffic information received from the user equipment is sent to the first base station selected from a pair of base stations including the first base station and the second base stations.

45. The method of claim 44, wherein the sending the updated uplink traffic information comprises sending a partial traffic information excluding a possibly scheduled amount on the first base station.

46. A method, comprising:
receiving an updated uplink traffic information from a first base station of a pair of base stations; and
assigning uplink resources to a user equipment to which the updated uplink traffic information relates.

47. The method of claim 46, wherein the receiving the updated uplink traffic information comprises receiving a partial traffic information excluding a possibly scheduled amount on the first base station.

48. The method of claim 46, further comprising:
signaling the user equipment when the user equipment is configured in inter-site carrier aggregation mode.

49. The method of claim 46, wherein the uplink traffic information comprises a buffer status report.

50. The method of claim 46, wherein the first base station comprises at least one of a Pico eNode B and a Macro eNode B.

51. An apparatus, comprising:
at least one processor; and
at least one memory including computer program code,
wherein the at least one memory and computer program code are configured to, with the at least one processor, cause the apparatus at least to
send, by a user equipment in a dual carrier mode carrier aggregation configuration, uplink traffic information to a first base station selected from a pair of base stations; and
receive a first uplink resource assignment from the first base station.

52. The apparatus of claim 51, wherein the at least one memory and computer program code are configured to, with the at least one processor, cause the apparatus at least to receive a second uplink resource assignment from a second base station of the pair of base stations.

53. An apparatus, comprising:
at least one processor; and
at least one memory including computer program code,
wherein the at least one memory and computer program code are configured to, with the at least one processor, cause the apparatus at least to
receive uplink traffic information from a user equipment in a dual carrier mode carrier aggregation configuration;
assign, at a first base station, uplink resources to the user equipment; and
send, from the first base station, an updated uplink traffic information to a second base station.

54. The apparatus of claim 53, wherein the uplink traffic information received from the user equipment is sent to the first base station selected from a pair of base stations including the first base station and the second base stations.

55. The apparatus of claim 54, wherein the at least one memory and computer program code are configured to, with the at least one processor, cause the apparatus at least to send the updated uplink traffic information by sending a partial traffic information excluding a possibly scheduled amount on the first base station.

56. An apparatus, comprising:
at least one processor; and
at least one memory including computer program code,
wherein the at least one memory and computer program code are configured to, with the at least one processor, cause the apparatus at least to
receive an updated uplink traffic information from a first base station of a pair of base stations; and
assign uplink resources to a user equipment to which the updated uplink traffic information relates.

57. The apparatus of claim 56, wherein the at least one memory and computer program code are configured to, with the at least one processor, cause the apparatus at least to receive the updated uplink traffic information by receiving a partial traffic information excluding a possibly scheduled amount on the first base station.

58. The apparatus of claim 56, wherein the at least one memory and computer program code are configured to, with the at least one processor, cause the apparatus at least to signal the user equipment when the user equipment is configured in inter-site carrier aggregation mode.

59. The apparatus of claim 56, wherein the uplink traffic information comprises a buffer status report.

60. The apparatus of claim 56, wherein the first base station comprises at least one of a Pico eNode Band a Macro eNode B.
